(19) United States
(12) Patent Application Publication
(10) Pub. No.: US 2007/0066359 A1
(43) Pub. Date: Mar. 22, 2007

(54) Cooperative transceiving between multiple wireless interfaces of a wireless device

(76) Inventor: Yuan Zhuang, San Diego, CA (US)

Correspondence Address: GARLICK HARRISON & MARKISON, P.O. BOX 160727, AUSTIN, TX, 78716-0727, US

(21) Appl. No.: 11/284,581

(22) Filed: Nov. 22, 2005

Related U.S. Application Data
(60) Provisional application No. 60/718,410, filed on Sep. 19, 2005.

(51) Int. Cl. H04B 1/38; H04M 1/00

(52) U.S. Cl. 455/557

(57) ABSTRACT

A wireless device includes host device components, a Wireless Personal Area Network (WPAN) interface, a Wireless Local Area Network (WLAN) interface, and shared TX/RX resources communicatively coupled to the WPAN interface and to the WLAN interface. For WPAN connection setup operations of the WPAN interface, the WPAN interface is operable to provide a first cooperative transceiving signal to the WLAN interface via a cooperative transceiving interface. For non WPAN connection setup operations of the WPAN interface, the WPAN interface is operable to provide a second cooperative transceiving signal to the WLAN interface via the cooperative transceiving interface. The WPAN interface provides the first cooperative transceiving signal and the second cooperative transceiving signal to the WLAN interface via a cooperative transceiving interface. The cooperative transceiving interface may include an RF active signal and at least one priority signal.

### CROSS REFERENCE TO RELATED APPLICATION

This application claims priority to U.S. Provisional Patent Application Ser. No. 60/718,410, filed Sep. 19, 2005, which is incorporated herein by reference in its entirety for all purposes.

### BACKGROUND OF THE INVENTION

1. Technical Field of the Invention

This invention relates generally to wireless communication systems and more particularly to cooperative transceiving by wireless interfaces of wireless device.

2. Description of Related Art

Communication systems are known to support wireless and wire lined communications between wireless and/or wire lined communication devices. Such communication systems range from national and/or international cellular telephone systems to the Internet to point-to-point in-home wireless networks. Each type of communication system is constructed, and hence operates, in accordance with one or more communication standards. For instance, wireless communication systems may operate in accordance with one or more standards including, but not limited to, IEEE 802.11, Bluetooth, advanced mobile phone services (AMPS), digital AMPS, global system for mobile communications (GSM), code division multiple access (CDMA), local multi-point distribution systems (LMDS), multi-channel-multi-point distribution systems (MMDS), and/or variations thereof.

Depending on the type of wireless communication system, a wireless communication device, such as a cellular telephone, two-way radio, personal digital assistant (PDA), personal computer (PC), laptop computer, home entertainment equipment, et cetera communicates directly or indirectly with other wireless communication devices. For direct communications (also known as point-to-point communications), the participating wireless communication devices tune their receivers and transmitters to the same channel or channels (e.g., one of the plurality of radio frequency (RF) carriers of the wireless communication system) and communicate over that channel(s). For indirect wireless communications, each wireless communication device communicates directly with an associated base station (e.g., for cellular services) and/or an associated access point (e.g., for an in-home or in-building wireless network) via an assigned channel. To complete a communication connection between the wireless communication devices, the associated base stations and/or associated access points communicate with each other directly, via a system controller, via the public switch telephone network, via the Internet, and/or via some other wide area network.

For each wireless communication device to participate in wireless communications, it includes a built-in radio transceiver (i.e., receiver and transmitter) or is coupled to an associated radio transceiver (e.g., a station for in-home and/or in-building wireless communication networks, RF modem, etc.). As is known, the transmitter includes a data modulation stage, one or more intermediate frequency stages, and a power amplifier. The data modulation stage converts raw data into baseband signals in accordance with a particular wireless communication standard. The one or more intermediate frequency stages mix the baseband signals with one or more local oscillations to produce RF signals. The power amplifier amplifies the RF signals prior to transmission via an antenna.

As is also known, the receiver is coupled to the antenna and includes a low noise amplifier, one or more intermediate frequency stages, a filtering stage, and a data recovery stage. The low noise amplifier receives inbound RF signals via the antenna and amplifies then. The one or more intermediate frequency stages mix the amplified RF signals with one or more local oscillations to convert the amplified RF signal into baseband signals or intermediate frequency (IF) signals. The filtering stage filters the baseband signals or the IF signals to attenuate unwanted out of band signals to produce filtered signals. The data recovery stage recovers raw data from the filtered signals in accordance with the particular wireless communication standard.

As the use of wireless communication devices increases, many wireless communication devices will include two or more radio transceivers, where each radio transceiver is compliant with a different wireless communication standard. For instance, a computer may include two radio transceivers: one for peripheral device interfacing and another for wireless local area network (WLAN) interfacing. Even though the two radio transceivers are compliant with different wireless communication standards, they may occupy the same or similar frequency spectrum, thus will interfere with each other's ability to receive inbound packets. For example, if one radio transceiver is compliant with Bluetooth and the other is compliant with IEEE 802.11, both radio transceivers would operate in the 2.4 GHz frequency range.

In this example, if the Bluetooth radio transceiver is receiving a packet and the IEEE 802.11 radio transceiver begins transmitting a packet, the transmission will interfere with the Bluetooth radio transceiver's ability to accurately receive the packet. Similarly, if the IEEE 802.11 radio transceiver is receiving a packet and the Bluetooth radio transceiver begins transmitting a packet, the transmission by the Bluetooth radio will interfere with the IEEE 802.11 radio transceiver's ability to accurately receive the packet. In addition, concurrent transmission by both the IEEE 802.11 radio transceiver and the Bluetooth radio transceiver may cause interference, thus corrupting the one or both transmissions.

In some wireless devices, multiple radio transceivers share one or more TX/RX components, e.g., antenna section, antenna, etc., for cost savings and size reduction purposes. With this construct, the multiple radio transceivers must compete for the shared TX/RX resources. Resource sharing must occur such that concurrent and communications of differing types, e.g., Bluetooth and IEEE 802.11, are supported. When one of these radio transceivers supports communications with Quality of Service (QoS) requirements, such as Voice over Internet Protocol (VoIP) service, the radio transceiver must have priority access during some times. Thus, the transceiver must have access to the shared resources when required to provide the necessary service. Often, each of the multiple radio transceivers must meet its own service requirements, resulting in conflicted access to the shared TX/RX resources. Therefore, a need exists for a method and apparatus that provides cooperation between two or more wireless interfaces (i.e., radio transceivers) of a wireless device to share TX/RX resources to support the requirements of each of the wireless interfaces.

### BRIEF SUMMARY OF THE INVENTION

The present invention is directed to apparatus and methods of operation that are further described in the following Brief Description of the Drawings, the Detailed Description of the Drawings, and the Claims. Other features and advantages of the present invention will become apparent from the following detailed description of the invention made with reference to the accompanying drawings.

### BRIEF DESCRIPTION OF THE SEVERAL VIEWS OF THE DRAWINGS

FIG. 1 is a schematic block diagram of a wireless communication system in accordance with the present invention;

FIG. 2 is a schematic block diagram of a wireless communication device in accordance with the present invention;

FIG. 3 is a schematic block diagram of a wireless interface device in accordance with the present invention;

FIG. 4 is a schematic block diagram of an embodiment of an antenna section in accordance with the present invention;

FIG. 5 is a schematic block diagram of another embodiment of an antenna section in accordance with the present invention;

FIG. 6 is a logic diagram of a method for cooperative transceiving between wireless interface devices of a host device in accordance with the present invention;

FIG. 7 is a logic diagram of another method for cooperative transceiving between wireless interface devices of a host device in accordance with the present invention;

FIG. 8 is a logic diagram of yet another method for cooperative transceiving between wireless interface devices of a host device in accordance with the present invention;

FIG. 9 is a diagram illustrating cooperative transceiving between wireless interface devices of a host device in accordance with the present invention;

FIG. 10 is a flow chart illustrating operation of a wireless device constructed according to the present invention;

FIG. 11 is a block diagram illustrating cooperative transceiving structure constructed according to an embodiment of the present invention;

FIG. 12 is a signal timing diagram illustrating cooperative transceiving signals provided by a WPAN interface during master connection mode operations according to an embodiment of the present invention;

FIG. 13 is a signal timing diagram illustrating cooperative transceiving signals provided by a WPAN interface during slave connection mode operations according to an embodiment of the present invention;

FIG. 14 is a signal timing diagram illustrating cooperative transceiving signals provided by a WPAN interface during page mode operations according to an embodiment of the present invention;

FIG. 15 is a signal timing diagram illustrating cooperative transceiving signals provided by a WPAN interface during page scan mode operations according to an embodiment of the present invention; and

FIG. 16 is a signal timing diagram illustrating cooperative transceiving signals provided by a WPAN interface during inquiry mode operations according to an embodiment of the present invention.

### DETAILED DESCRIPTION OF THE INVENTION

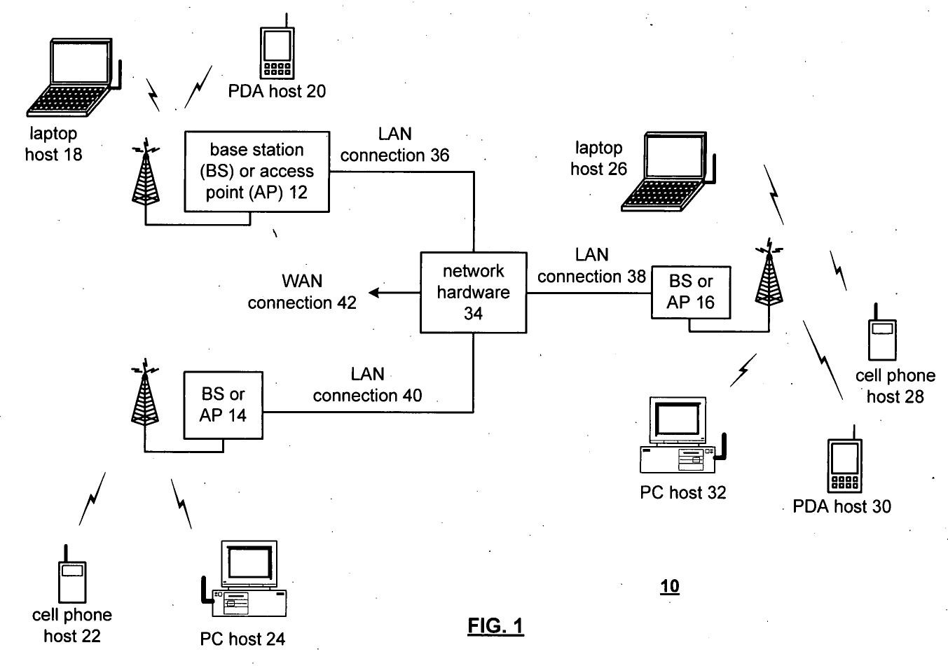

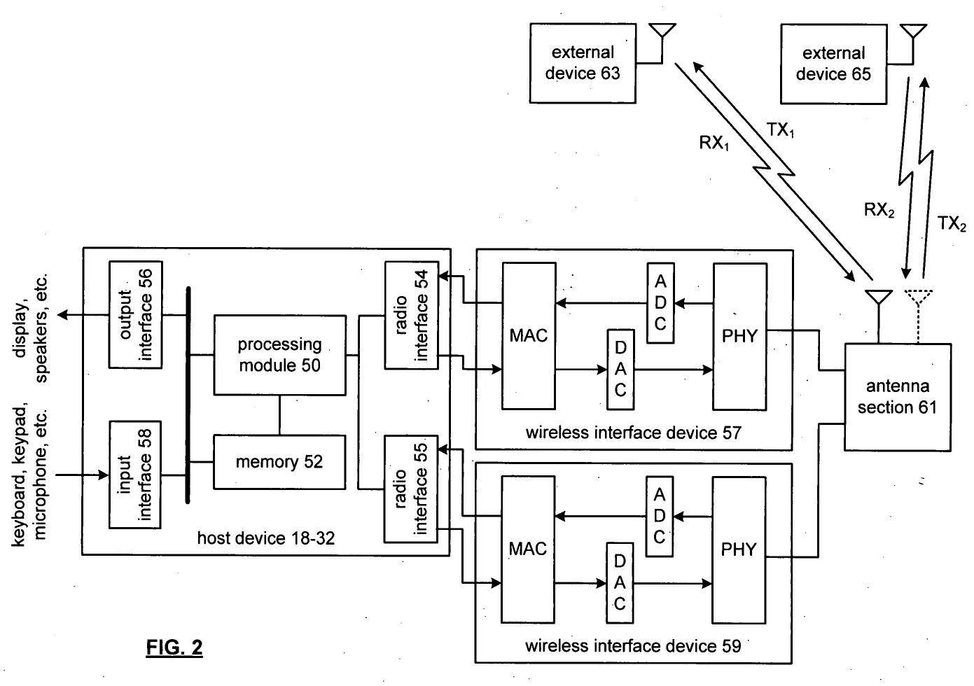

FIG. 1 is a schematic block diagram illustrating a communication system 10 that includes a plurality of base stations and/or access points 12-16, a plurality of wireless communication devices 18-32 and a network hardware component 34. The wireless communication devices 18-32 may be laptop host computers 18 and 26, personal digital assistant hosts 20 and 30, personal computer hosts 24 and 32, and/or cellular telephone hosts 22 and 28. The details of the wireless communication devices and of their operation will be described in detail with reference to FIGS. 2-16.

The base stations or access points 12-16 are operably coupled to the network hardware 34 via local area network connections 36, 38 and 40. The network hardware 34, which may be a router, switch, bridge, modem, system controller, et cetera provides a wide area network connection 42 for the communication system 10. Each of the base stations or access points 12-16 has an associated antenna or antenna array to communicate with the wireless communication devices in its area. Typically, the wireless communication devices register with a particular base station or access point 12-14 to receive services from the communication system 10. For direct connections (i.e., point-to-point communications), wireless communication devices communicate directly via an allocated channel.

Typically, base stations are used for cellular telephone systems and like-type systems, while access points are used for in-home or in-building wireless networks. Regardless of the particular type of communication system, each wireless communication device includes a built-in radio and/or is coupled to a radio. The radio includes a highly linear amplifier and/or programmable multi-stage amplifier as disclosed herein to enhance performance, reduce costs, reduce size, and/or enhance broadband applications.

FIG. 2 is a schematic block diagram illustrating a wireless communication device that includes the host device, or module, 18-32 and at least two wireless interface devices 57 and 59, also referred to herein as wireless interfaces and radio transceivers. The wireless interface devices may be built in components of the host device 18-32 or externally coupled components. As illustrated, the host device 18-32 includes a processing module 50, memory 52, radio interfaces 54 and 55, input interface 58 and output interface 56. The processing module 50 and memory 52 execute the corresponding instructions that are typically done by the host device. For example, for a cellular telephone host device, the processing module 50 performs the corresponding communication functions in accordance with a particular cellular telephone standard.

The radio interfaces 54 and 55 each include a media-specific access control protocol (MAC) layer module, a digital-to-analog converter (DAC), an analog to digital converter (ADC), and a physical layer module (PHY). The radio interfaces 54 and 55 allow data to be received from and sent to external devices 63 and 65 via the wireless interface devices 57 and 59. Each of the external devices includes its own wireless interface device for communicating with the wireless interface device of the host device. For example, the host device may be personal or laptop computer, the external device 63 may be a headset, personal digital assistant, cellular telephone, printer, fax machine, joystick, keyboard, or desktop telephone and the second external device 65 may be an access point of a wireless local area network. In this example, the external device 63 would include a Bluetooth wireless interface device, external device 65 would include an IEEE 802.11 wireless interface device, and the computer would include both types of wireless interface devices.

In operation, to avoid interference between the two or more wireless interface devices 57 and 59 of the wireless communication device, the MAC layer modules of each wireless interface device 57 and 59 communicate with each other to avoid concurrent transmission and/or reception of wireless transmissions with the corresponding external device if such concurrent transmission or reception would cause interference. The methods in which the MAC layer modules communicate are illustrated in FIGS. 6-16.

For data received from one of the wireless interface devices 57 or 59 (e.g., inbound data), the radio interface 54 or 55 provides the data to the processing module 50 for further processing and/or routing to the output interface 56. The output interface 56 provides connectivity to an output display device such as a display, monitor, speakers, et cetera such that the received data may be displayed. The radio interfaces 54 and 55 also provide data from the processing module 50 to the wireless interface devices 57 and 59. The processing module 50 may receive the outbound data from an input device such as a keyboard, keypad, microphone, et cetera via the input interface 58 or generate the data itself. For data received via the input interface 58, the processing module 50 may perform a corresponding host function on the data and/or route it to one of the wireless interface devices 57 or 59 via the corresponding radio interface 54 or 55.

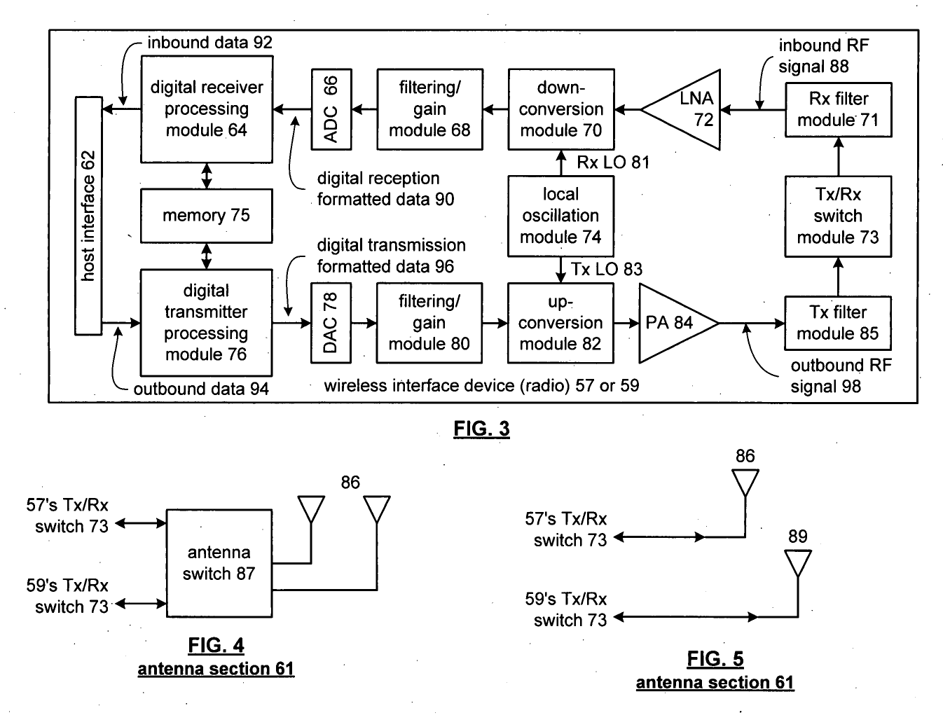

FIG. 3 is a schematic block diagram of the wireless interface devices (i.e., a radio) 57 or 59, where each device includes a host interface 62, digital receiver processing module 64, an analog-to-digital converter (ADC) 66, a filtering/attenuation module 68, an IF mixing down conversion stage 70, a receiver filter 71, a low noise amplifier 72, a transmitter/receiver switch 73, a local oscillation module 74, memory 75, a digital transmitter processing module 76, a digital-to-analog converter (DAC) 78, a filtering/gain module 80, an IF mixing up conversion stage 82, a power amplifier 84, and a transmitter filter module 85. The transmitter/receiver switch 73 is coupled to the antenna section 61, which may include two antennas 86 and an antenna switch 87 (as shown in FIG. 4) that is shared by the two wireless interface devices and is further shared by the transmit and receive paths as regulated by the TX/RX switch 73. Alternatively, the antenna section 61 may include separate antennas for each wireless interface device (as shown in FIG. 5), where the transmit path and receive path of each wireless interface device shares the antenna. Still further, the antenna section 61 may include a separate antenna for the transmit path and the receive path of each wireless interface device. As one of average skill in the art will appreciate, the antenna(s) may be polarized, directional, and be physically separated to provide a minimal amount of interference.

Continuing with the discussion of FIG. 3, the digital receiver processing module 64 the digital transmitter processing module 76, and the memory 75 may be included in the MAC module and execute digital receiver functions and digital transmitter functions in accordance with a particular wireless communication standard. The digital receiver functions include, but are not limited to, digital intermediate frequency to baseband conversion, demodulation, constellation demapping, decoding, and/or descrambling. The digital transmitter functions include, but are not limited to, scrambling, encoding, constellation mapping, modulation, and/or digital baseband to IF conversion. The digital receiver and transmitter processing modules 64 and 76 may be implemented using a shared processing device, individual processing devices, or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions. The memory 75 may be a single memory device or a plurality of memory devices. Such a memory device may be a read-only memory, random access memory, volatile memory, non-volatile memory, static memory, dynamic memory, flash memory, and/or any device that stores digital information. Note that when the processing module 64 and/or 76 implements one or more of its functions via a state machine, analog circuitry, digital circuitry, and/or logic circuitry, the memory storing the corresponding operational instructions is embedded with the circuitry comprising the state machine, analog circuitry, digital circuitry, and/or logic circuitry.

In operation, the wireless interface device 57 or 59 receives outbound data 94 from the host device via the host interface 62. The host interface 62 routes the outbound data 94 to the digital transmitter processing module 76, which processes the outbound data 94 in accordance with a particular wireless communication standard (e.g., IEEE 802.11—including all current and future subsections—, Bluetooth, et cetera) to produce digital transmission formatted data 96. The digital transmission formatted data 96 will be a digital base-band signal or a digital low IF signal, where the low IF typically will be in the frequency range of one hundred kilohertz to a few megahertz.

The digital-to-analog converter 78 converts the digital transmission formatted data 96 from the digital domain to the analog domain. The filtering/gain module 80 filters and/or adjusts the gain of the analog signal prior to providing it to the IF mixing stage 82. The IF mixing stage 82 directly converts the analog baseband or low IF signal into an RF signal based on a transmitter local oscillation 83 provided by local oscillation module 74. The power amplifier 84 amplifies the RF signal to produce outbound RF signal 98, which is filtered by the transmitter filter module 85. The antenna section 61 transmits the outbound RF signal 98 to a targeted device such as a base station, an access point and/or another wireless communication device.

The wireless interface device 57 or 59 also receives an inbound RF signal 88 via the antenna section 61, which was transmitted by a base station, an access point, or another wireless communication device. The antenna section 61 provides the inbound RF signal 88 to the receiver filter module 71 via the TX/RX switch 73, where the Rx filter 71 bandpass filters the inbound RF signal 88. The Rx filter 71 provides the filtered RF signal to low noise amplifier 72, which amplifies the signal 88 to produce an amplified inbound RF signal. The low noise amplifier 72 provides the amplified inbound RF signal to the IF mixing module 70, which directly converts the amplified inbound RF signal into an inbound low IF signal or baseband signal based on a receiver local oscillation 81 provided by local oscillation module 74. The down conversion module 70 provides the inbound low IF signal or baseband signal to the filtering/gain module 68. The filtering/gain module 68 filters and/or gains the inbound low IF signal or the inbound baseband signal to produce a filtered inbound signal.

The analog-to-digital converter 66 converts the filtered inbound signal from the analog domain to the digital domain to produce digital reception formatted data 90. The digital receiver processing module 64 decodes, descrambles, demaps, and/or demodulates the digital reception formatted data 90 to recapture inbound data 92 in accordance with the particular wireless communication standard being implemented by wireless interface device. The host interface 62 provides the recaptured inbound data 92 to the host device 18-32 via the radio interface 54.

As one of average skill in the art will appreciate, the wireless interface device of FIGS. 2 and 3 may be implemented using one or more integrated circuits. For example, the host device may be implemented on one integrated circuit, the digital receiver processing module 64, the digital transmitter processing module 76 and memory 75 may be implemented on a second integrated circuit, and the remaining components of the radio 60, less the antennas 86, may be implemented on a third integrated circuit. As an alternate example, the radio 60 may be implemented on a single integrated circuit. As yet another example, the processing module 50 of the host device and the digital receiver and transmitter processing modules 64 and 76 may be a common processing device implemented on a single integrated circuit. Further, the memory 52 and memory 75 may be implemented on a single integrated circuit and/or on the same integrated circuit as the common processing modules of processing module 50 and the digital receiver and transmitter processing module 64 and 76.

FIG. 6 is a logic diagram of a method for cooperative transceiving between wireless interface devices of a host device. The method begins at step 100, where one of the wireless interface devices provides an indication of receiving an inbound packet to another one of the wireless interface devices. For example, one of the wireless interface devices transceives data packets in accordance with a Bluetooth standard while the other wireless interface devices transceives data packets in accordance with an IEEE 802.11 standard.

The method then proceeds to step 102, where the other wireless interface device processes the indication. The method then proceeds to step 104, where the other wireless interface device transmits an outbound packet in accordance with the processing of the indication. For example, the processing may be done to determine when the first wireless interface device is receiving the inbound packet. If so, the other wireless interface device delays transmitting the outbound packet until the one of the wireless interface devices has received the inbound packet. Note that to minimize the time that one wireless interface device is receiving packets, and hence reduce the wait time, the packet size of inbound packets and outbound packets may be optimized in accordance with the particular wireless communication standard.

As a further example of steps 102 and 104, the processing of the indication may be to determine whether the transmitting of the outbound packet would interfere with the receiving of the inbound packet. If so, the other wireless interface device delays transmitting the outbound packet until the one of the wireless interface devices has received the inbound packet. If the transmitting of the outbound packet would not interfere with the receiving of the inbound packet, the other wireless interface device transmits the outbound packet while the inbound packet is being received. Note that to reduce interference, the wireless interface device that is compliant with the Bluetooth standard may adaptively adjust its frequency hopping sequence to reduce interference with the other wireless interface device.

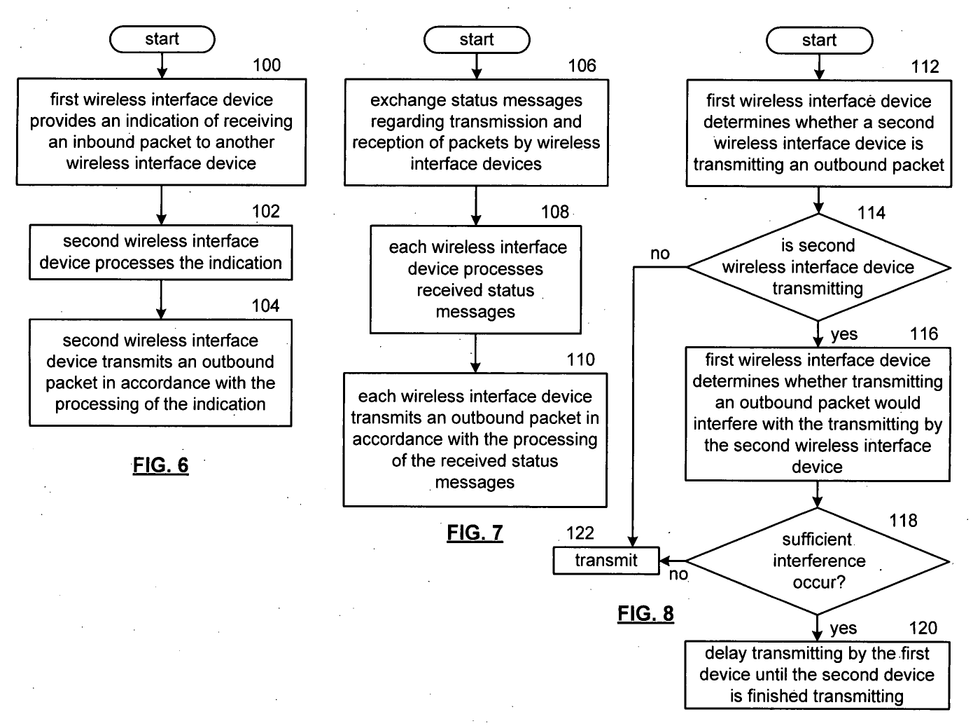

FIG. 7 is a logic diagram of another method for cooperative transceiving between wireless interface devices of a host device. The process begins at step 106, where the wireless interface devices exchange status messages regarding transmission and reception of packets. Note that a status message may be provided in response to a request from the other wireless communication device for a particular piece of information, for a full status report, or any portion thereof. The method then proceeds to step 108, where each of the wireless interface devices process the received status messages. The method then proceeds to step 110, where each of the wireless interface devices transmits an outbound packet in accordance with the processing of the received status messages.

In one example of the processing of the status message and transmitting of the outbound packet, the wireless interface device determines that the other wireless interface device is currently receiving an inbound packet. In this situation, the wireless interface devices delays transmitting of the outbound packet until the other wireless interface device has received the inbound packet.

In another example of the processing of the status message and transmitting of the outbound packet, the wireless interface device determines that the other wireless interface device is expecting to receive an inbound packet. In this situation, the wireless interface device delays transmitting of the outbound packet until the other wireless interface device has received the inbound packet unless the delay would cause an interrupt for low latency real time transmissions.

In yet another example of the processing of the status message and transmitting of the outbound packet, the wireless interface device determines that the other wireless interface device is transmitting an outbound message. In this situation, the wireless interface device delays transmitting of the outbound packet until the other wireless interface device has transmitted the inbound packet unless interference would be minimal or if a delay would cause an interrupt for low latency real time transmissions.

In a further example of the processing of the status message and transmitting of the outbound packet, the wireless interface device determines that the other wireless interface device is expecting to transmit another outbound message. In this situation, the wireless interface device randomizing the delaying transmitting the outbound packet in accordance with a random transmission protocol. For example, each wireless interface device may be assigned a unique wait period when they detect that two or more wireless interface devices desire to transmit a packet at about the same time.

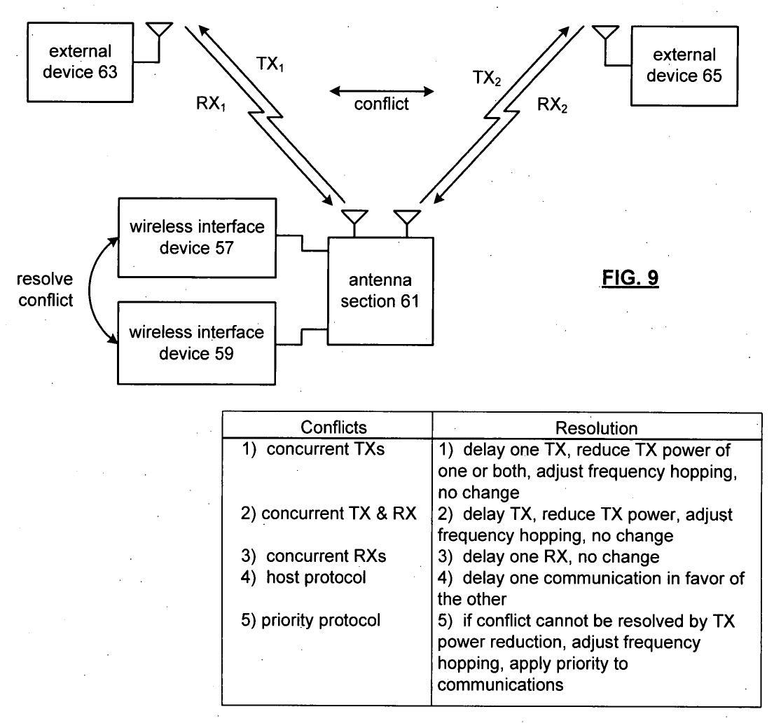

FIG. 8 is a logic diagram of yet another method for cooperative transceiving between wireless interface devices of a host device. The method begins at step 112 where a first wireless interface device determines whether a second wireless interface device is transmitting an outbound packet. If, as established at step 114, the second wireless interface device is not transmitting, the method precedes to step 122, where the first wireless interface device transmits its packet. If, however, the second wireless interface device is transmitting, the method precedes to step 116, where the first wireless interface device determines whether transmitting its outbound packet would interfere with the transmitting of the second outbound packet. This may be done by comparing the transmit power level of the first wireless interface device with the transmit power level of the second wireless interface device. If they are similar and relatively low, the interference may be minimal.

The method then proceeds to step 118 where a determination is made as to whether the interference is of a level that would jeopardize the integrity of the second outbound packet. If not, the method precedes to step 122, where the packet is transmitted. If, however, there would be sufficient interference, the method precedes to step 120 where the first wireless interface device delays transmitting the first outbound packet until the second outbound packet has been transmitted.

FIG. 9 is a diagram illustrating wireless interface devices 57 and 59 associated with a host device 18-32 coordinating communications with two external wireless devices 63 and 65. The wireless interface devices 57 and 59 and the external wireless devices 63 and 65 may communication using any type of standardized wireless communication including, but not limited to, IEEE 822.11 (a), (b), (g), or (n) Bluetooth, IEEE 802.15, IEEE 802.16, GSM, CDMA, TDMA, LMPS, MMPS, or another wireless standard. The external devices 63 and 65 may use the same or different wireless communication standard. When the external devices 63 and 65 use standards that occupy the same or similar frequency spectrums, a conflict between concurrent communications may occur. In other words, when the both external devices are communicating with the wireless interface devices 57 and 59 their respective communications may interfere with the other's communication, reducing the quality of service for one or both communications.

To resolve the conflict, the wireless interface devices 57 and 59 coordinate the communications with their respective external devices 63 and 65. As shown in the accompanying table of FIG. 9, when a conflict arises, the wireless interface devices 57 and 59 have a multitude of resolutions. For example, when both wireless interface devices 57 and 59 desire to concurrently transmit packets to their respective external devices 63 and 65 (i.e., concurrently includes any overlap of transmission), the wireless interface devices 57 and 59 determine whether a concurrent transmission would cause sufficient interference that would degrade one or both of the transmissions. If not, the resolution is to do nothing and concurrently transmit.

If, however, sufficient interference would exist, the wireless interface devices may delay one of the transmissions with respect to the other to avoid concurrent transmissions, reduce the transmit power for one or both of the concurrent transmissions, and/or adjust the frequency hopping of a Bluetooth compliant wireless interface device 57 or 59. The wireless interface devices 57 and 59 may delay the transmissions based on a priority protocol, a host protocol, a default mechanism, an ad hoc mechanism, or a user defined ordering. In essence, the delaying of the concurrent transmissions removes the concurrency such that only one transmission is occurring at any given time. The delaying may be established by an equal or imbalanced staggering of the transmissions or by allowing one of the communications to complete before the other is serviced. For example, the host protocol may prohibit concurrent communications. As such, the communication with one of external devices that was initiated first will be completed before communication with the other external devices is serviced.

As a further example of the delaying of concurrent transmissions, the priority protocol may dictate that user interface wireless devices (e.g., wireless keyboard, mouse, etc.) may have priority over data transfer peripheral wireless devices (e.g., PDA, down loading data to a cell phone, a printer, etc.). The priority protocol may also prioritize real time communications (e.g., voice, audio, and/or video data) over data transfer communications. In addition, the priority protocol may indicate whether the concurrent transmissions are to be staggered or sequential.

The user defiled priority list may be based on the type of external devices. For example, the user may priority communications with his or her PDA over any other type of communications, followed by communications with the cell phone, etc. In this manner, the conflict resolution may be customized to the user's preferences.

When the conflict corresponds to one wireless interface device potentially transmitting data while the other wireless interface device is potentially receiving data, the wireless interface devices determine whether concurrent transmission and reception would cause significant interference. If not, the current transmission and reception is performed. If, however, significant interference would be produced, the wireless interface device may resolve the conflict by delaying the transmission to avoid the concurrency, delaying the reception to avoid the concurrency, reducing the transmit power, adjusting the frequency hopping of a Bluetooth device, process the conflict based on the host protocol and/or based on the priority protocol.

When the conflict corresponds to concurrent receptions, the wireless interface devices determine whether such concurrency would cause significant interference. If not, the concurrent receptions are processed. If, however, significant interference would exist, one of the receptions may be delayed to avoid the concurrency, one of the external devices may be instructed to reduce its transmitting power.

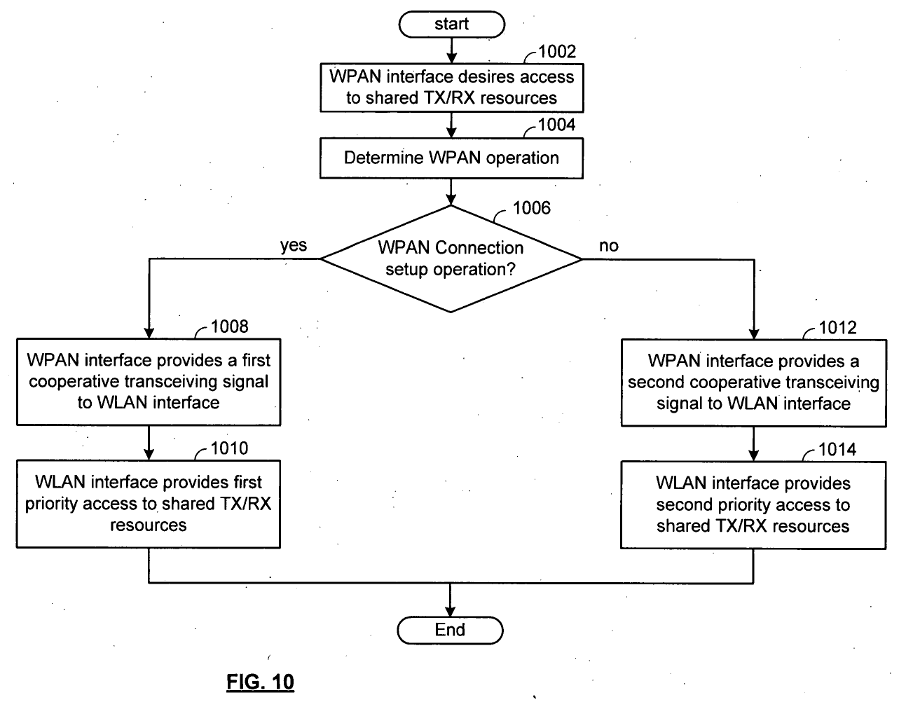

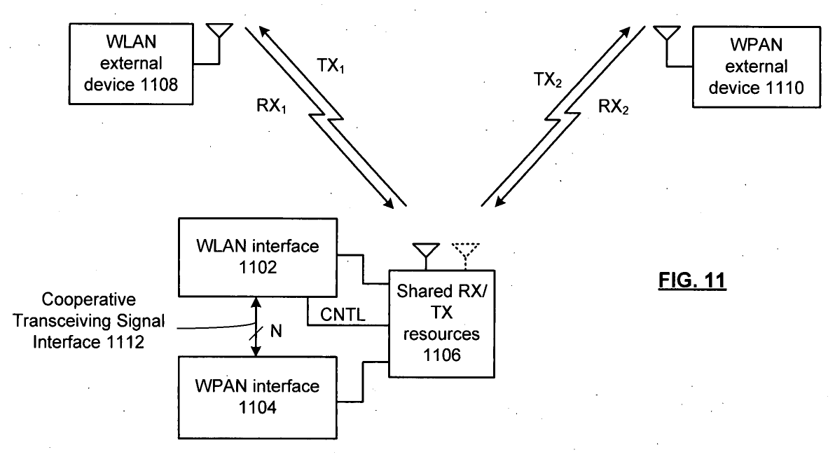

FIG. 10 is a flow chart illustrating operation of a wireless device constructed according to the present invention. This wireless device may be similar to, or the same as the wireless device illustrated in FIG. 2, which includes a WPAN interface, a WLAN interface, host device components, and shared TX/RX resources. Both the WPAN interface and the WLAN interface communicatively couple to the host device components and to the shared TX/RX resources. The shared TX/RX resources may include antenna switches 87, antennas 86, and other components that may be shared within a wireless device to conserve space, cost, and/or reduce power consumption.

The operations of FIG. 10 commence with the WPAN interface desiring access to the shared TX/RX resources (step 1002). Operation continues with the WPAN interface determining what type of WPAN operation(s) is/are to be performed (step 1004). These WPAN operations are, generally, connection setup operations and non connection setup operations. As is generally known, connection setup operations are those operations employed by a WPAN interface when attempting to establish a connection with another WPAN network device(s). According to the Bluetooth operating standard, connection setup operations include page mode operations, page scan mode operations, inquiry operations, and inquiry scan mode operations. Other operating standards include similar/same operations.

The WPAN interface then determines whether the WPAN operation is a connection setup operation (step 1006). When the WPAN operation is a WPAN connection setup operation, the WPAN interface provides a first cooperative transceiving signal to the WLAN interface (step 1008). In response to the first cooperative transceiving signal provided at step 1008, the WLAN interface provides first priority access to the shared TX/RX resources (step 1010). When the WPAN operation is not a connection setup operation, the WPAN interface provides a second cooperative transceiving signal to the WLAN interface (step 1012). In response to the second cooperative transceiving signal, the WLAN interface provides second priority access to the shared TX/RX resources (step 1014). From both steps 1010 and 1014, operation ends.

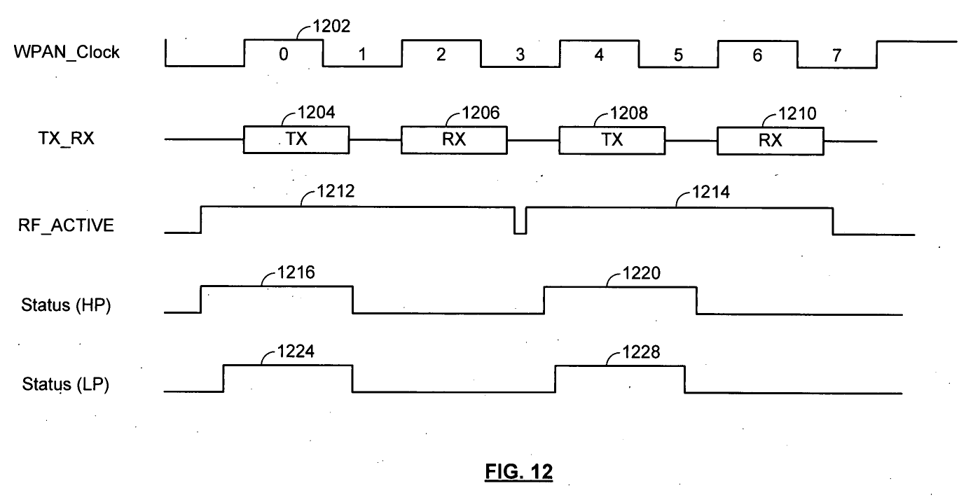

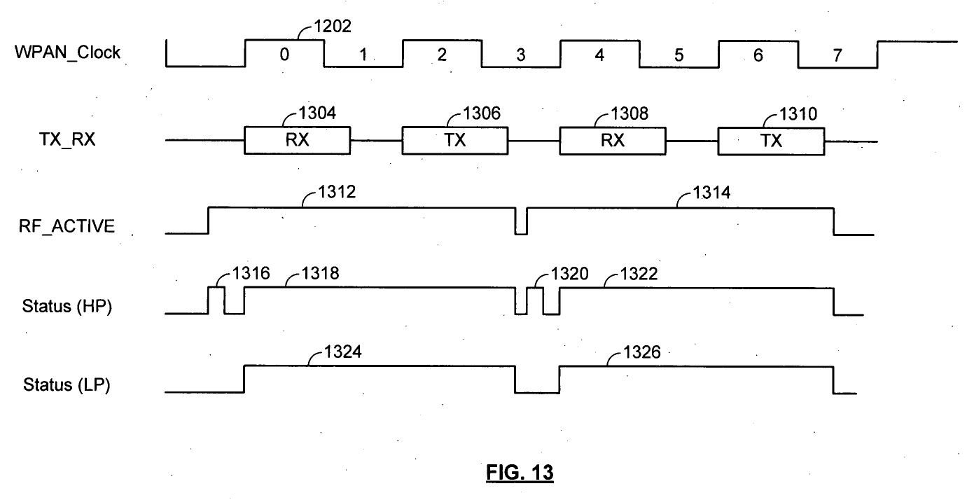

FIG. 11 is a block diagram illustrating cooperative transceiving structure constructed according to an embodiment of the present invention. In particular, FIG. 11 shows the WPAN wireless interface 1104, the WLAN wireless interface 1102, the shared TX/RX resources 1106, a WLAN external device 1108, and a WPAN external device 1110. The WLAN wireless interface 1102 and the WPAN wireless interface 1104 exchange at least one cooperative transceiving signal via cooperative transceiving signal interface 1112. This cooperative transceiving signal interface 1112 includes multiple signal lines in some embodiments. As shown in FIG. 11, the cooperative transceiving signal interface 1112 includes N signal lines. The signals asserted on these N signal lines will be described further with reference to FIGS. 12-16.

According to the embodiment of FIG. 11, the WLAN wireless interface 1102 controls access to the shared TX/RX resources 1106. Thus, in accessing the shared TX/RX resources 1106, the WPAN wireless interface 1104 must make requests to the WLAN wireless interface 1102 via the cooperative transceiving signal interface 1112. As was previously described with reference to FIG. 10, for connection setup operations, the WPAN interface 1104 provides a first cooperative transceiving signal to the WLAN interface 1102 via the cooperative transceiving signal interface 1112. Further, for non-connection setup operations, the WPAN interface 1104 provides a second cooperative transceiving signal to the WLAN interface 1102 via the cooperative transceiving signal interface 1112. When the WPAN interface 1104 signals its connection setup operations to the WLAN interface 1102, the WPAN interface 1104 provides higher priority access to the shared TX/RX resources 1106 than during non-connection setup operations.

As will be further described with the embodiments of FIGS. 12-16, the cooperative transceiving signal interface 1112 includes an RX_ACCESS signal and at least one priority signal. The cooperative transceiving signal interface 1112 may further support a third cooperative transceiving signal that is provided to the WPAN interface 1104 by the WLAN interface 1102. In various embodiments, the WLAN interface 1102 may operate an antenna switch in a first manner in response to the first cooperative transceiving signal and operate the antenna switch in a second manner in response to the second cooperative transceiving signal.

FIG. 12 is a signal timing diagram illustrating cooperative transceiving signals provided by a WPAN interface during master connection mode operations according to an embodiment of the present invention. The operations described with reference to FIG. 12 are connection operations in which a master WPAN device transmits data to and receives data from a slave WPAN device. The operations of FIG. 12 are performed after a connection has been established between the master WPAN device and the slave WPAN device.

A WPAN_Clock 1202 includes clock phases labeled with digits 0-7 and operates at a standard clock frequency. The WPAN_Clocks of WPAN devices within a piconet are substantially synchronized and serve as transmit and receive time references. A TX_RX signal indicates a transmit or a receive operation of the WPAN device. As shown, the WPAN master device transmits during intervals 1204 and 1208 receives during intervals 1206 and 1210. Signals of the cooperative transceiving signal interface 1112 illustrated in FIG. 12 include an RF_ACTIVE signal, a high priority status signal [Status (HP)], and a low priority status signal [Status (LP)].

As is shown in FIG. 12, the master WPAN device asserts the RF_ACTIVE signal (logic high) over an interval 1212 that encompasses TX interval 1204 and RX interval 1206. Likewise, the WPAN device asserts the RF_ACTIVE signal over an interval 1214 that encompasses TX interval 1208 and RX interval 1210. The high priority status signal Status (HP) is asserted (logic high) over intervals 1216 and 1222. The low priority status signal Status (LP) is asserted (logic high) over intervals 1224 and 1228. The status signals indicate the relative importance that the WPAN interface places on obtaining the shared TX/RX resources.

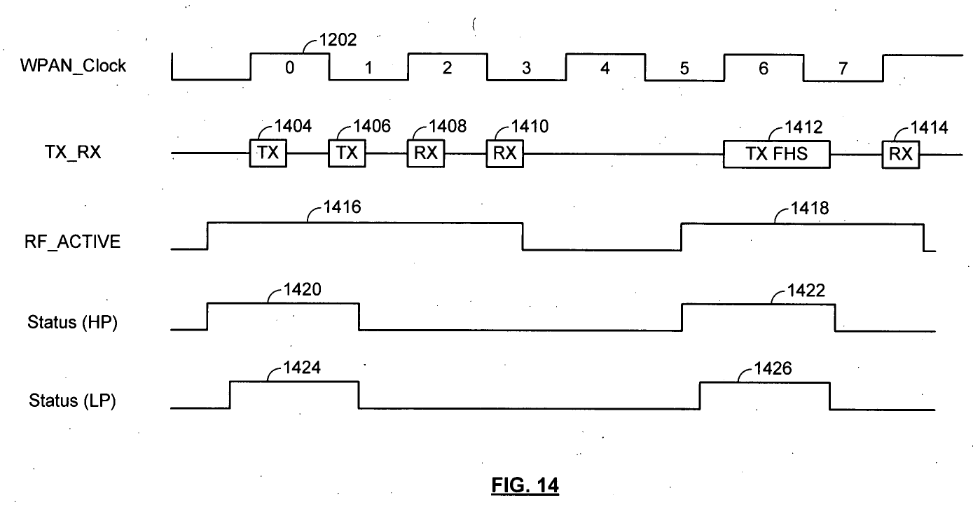

FIG. 13 is a signal timing diagram illustrating cooperative transceiving signals provided by a WPAN interface during slave connection mode operations according to an embodiment of the present invention. The WPAN interface asserts these signals across the cooperative transceiving signal interface 1112 during WPAN slave connection operations. Shown in FIG. 13 are the WPAN_Clock 1202, the TX_RX signal, the RF_ACTIVE signal, and the high priority and low priority status signals. As is shown, the RF_ACTIVE signal is logic high during interval 1312 over both RX interval 1304 and TX interval 1306, which support connection operations. Likewise, the RF_ACTIVE signal is logic high over interval 1314 that includes RX interval 1306 and TX interval 1310. Note that the RF_ACTIVE signal is high during a single pair of RX and TX operations. The low priority status and high priority status signals are asserted (logic high) during indicated intervals 1316, 1318, 1320, 1322, 1324, and 1326.

FIG. 14 is a signal timing diagram illustrating cooperative transceiving signals provided by a WPAN interface during page mode operations according to an embodiment of the present invention. The page mode operations of the WPAN interface illustrated in FIG. 14 occur for a WPAN interface acting as a master device. As illustrated in FIG. 14, the RF_ACTIVE signal is logic high during interval 1416 that extends across multiple TX 1404 and 1406 operations and multiple RX 1408 and 1410 operations of the WPAN interface. Further, during logic high interval 1418 of the RF_ACTIVE signal, the WPAN interface performs transmit frequency hop sequence 1412 operations and RX 1414 operations. The high priority and low priority status signals are logic high over intervals 1416, 1418, 1420, 1422, 1424, and 1426. Thus, with the page mode operations illustrated in FIG. 14, the first cooperative transceiving signal includes an asserted RF_ACTIVE signal over interval 1416 that encompasses a plurality of TX intervals 1404 and 1406 and a plurality of RX intervals 1408 and 1410.

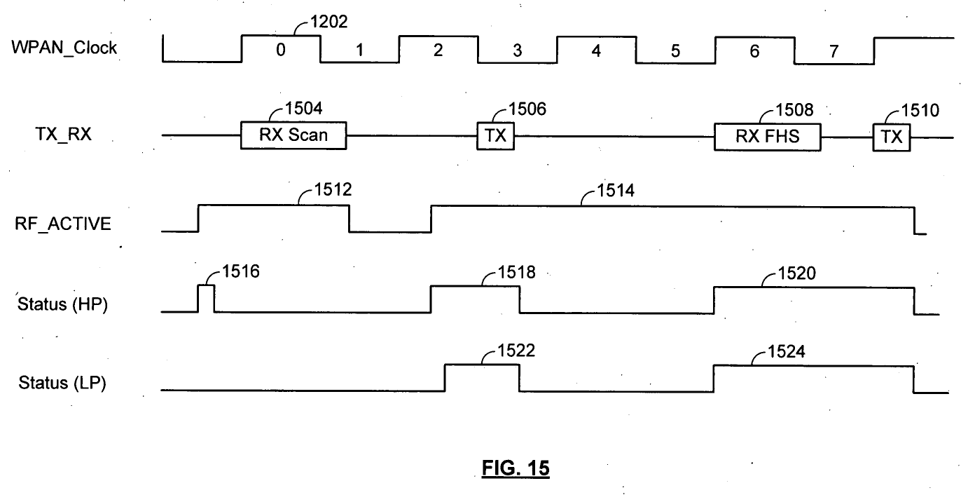

FIG. 15 is a signal timing diagram illustrating cooperative transceiving signals provided by a WPAN interface during page scan mode operations according to an embodiment of the present invention. Generally, page scan mode operations are performed by WPAN interface when operating as a WPAN slave and awaiting a page from a master WPAN device. The WPAN interface performs an RX scan at interval 1504, responds with a TX operation 1506, performs a RX frequency hopping sequence operation at 1508, and transmits a confirmation at 1510. As is shown, the RF_ACTIVE signal is logic high over interval 1512 during the RX scan operation 1504. Further, the RF_ACTIVE signal is logic high over interval 1514 during the TX operations 1506 and 1510 and the RX frame hop sequence operation 1508. The high priority and low priority status signals are logic high over intervals 1516, 1518, 1520, 1522, and 1524.

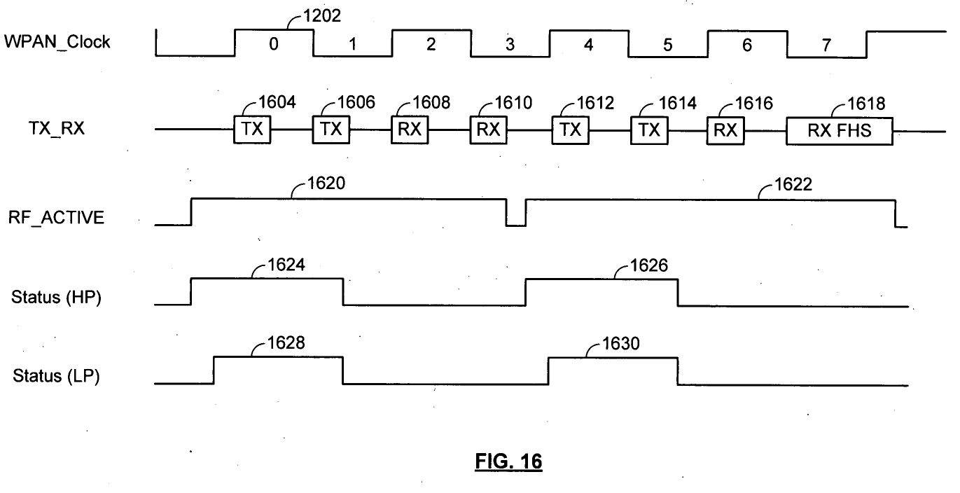

FIG. 16 is a signal timing diagram illustrating cooperative transceiving signals provided by a WPAN interface during inquiry mode operations according to an embodiment of the present invention. Generally, in the inquiry mode operation, the WPAN interface inquires for at least one other WPAN device within a communication range of the WPAN interface. As is shown, during the inquiry mode operations, the WPAN device transmits at TX intervals 1604, 1606, 1612, and 1614. Further, the WPAN interface receives at RX intervals 1608, 1610, and 1616. Further, the WPAN interface receives frame hop sequence data at interval 1618.

According to the operation of FIG. 16, the RF_ACTIVE signal of the cooperative transceiving signal interface 1112 is active high over interval 1620 for a plurality of RX intervals 1608 and 1610 and a plurality of TX intervals 1604 and 1606. Further, the RF_ACTIVE signal is logic high over interval 1622 that includes TX intervals 1612 and 1614 and RX intervals 1616 and 1618. The priority status signals are logic high over intervals 1624, 1626, 1628, and 1630.

As one of average skill in the art will appreciate, the term “communicatively coupled”, as may be used herein, includes wireless and wired, direct coupling and indirect coupling via another component, element, circuit, or module. As one of average skill in the art will also appreciate, inferred coupling (i.e., where one element is coupled to another element by inference) includes wireless and wired, direct and indirect coupling between two elements in the same manner as “communicatively coupled”.

The present invention has also been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention.

The present invention has been described above with the aid of functional building blocks illustrating the performance of certain significant functions. The boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention.

One of average skill in the art will also recognize that the functional building blocks, and other illustrative blocks, modules and components herein, can be implemented as illustrated or by discrete components, application specific integrated circuits, processors executing appropriate software and the like or any combination thereof.

Moreover, although described in detail for purposes of clarity and understanding by way of the aforementioned embodiments, the present invention is not limited to such embodiments. It will be obvious to one of average skill in the art that various changes and modifications may be practiced within the spirit and scope of the invention, as limited only by the scope of the appended claims.

What is claimed is:

1. A method for operating a wireless device having a Wireless Personal Area Network (WPAN) interface and a Wireless Local Area Network (WLAN) interface that share TX/RX resources, the method comprising:
for WPAN connection setup operations of the WPAN interface, the WPAN interface providing a first cooperative transceiving signal to the WLAN interface via a cooperative transceiving interface; and
for non WPAN connection setup operations of the WPAN interface, the WPAN interface providing a second cooperative transceiving signal to the WLAN interface via the cooperative transceiving interface.

2. The method of claim 1, wherein:
the WPAN interface providing the first cooperative transceiving signal to the WLAN interface via the cooperative transceiving interface comprises:
asserting an RF active signal for a first duration; and
asserting a first priority signal;
the WPAN interface providing the second cooperative transceiving signal to the WLAN interface via the cooperative transceiving interface comprises:
asserting the RF active signal for a second duration that differs from the first duration; and
asserting a second priority signal that differs from the first priority signal.

3. The method of claim 2, further comprising the WLAN interface providing a third cooperative transceiving signal to the WPAN interface via the cooperative transceiving interface.

4. The method of claim 1, further comprising:
in response to the first cooperative transceiving signal received from the WPAN interface via the cooperative transceiving interface, the WLAN interface providing priority access to the shared TX/RX resources to the WPAN interface; and
in response to the second cooperative transceiving signal received from the WPAN interface via the cooperative transceiving interface, the WLAN interface providing non priority access to the shared TX/RX resources to the WPAN interface.

5. The method of claim 1, wherein:
the WPAN interface transceives data packets via the shared TX/RX resources in accordance with at least one version of the Bluetooth operating standard; and
the WLAN interface transceives data packets via the shared TX/RX resources in accordance with at least one version of the IEEE 802.11 operating standard.

6. The method of claim 1, further comprising:
the WLAN interface operating an antenna switch in a first manner in response to the first cooperative transceiving signal; and
the WLAN interface operating the antenna switch in a second manner in response to the second cooperative transceiving signal.

7. The method of claim 1, wherein:
the connection setup operations comprise page mode operations during which the WPAN interface pages another WPAN device; and
the first cooperative transceiving signal includes an asserted RF active signal over a plurality of transmit intervals and a plurality of receive intervals of the page mode operations.

8. The method of claim 1, wherein:
the connection setup operations comprise page scan mode operations during which the WPAN interface receives a page from another WPAN device; and
the first cooperative transceiving signal includes an asserted RF active signal over a plurality of transmit intervals and a frame hope sequence receive interval of the page scan mode operations.

9. The method of claim 1, wherein:
the connection setup operations comprise inquiry mode operations during which the WPAN interface inquires for at least one other WPAN device; and
the first cooperative transceiving signal includes an asserted RF active signal over a plurality of transmit intervals and a plurality of receive intervals of the inquiry mode operations.

10. The method of claim 1, wherein the first cooperative transceiving signal includes an asserted RF active signal over a plurality of transmit intervals and a plurality of receive intervals.

11. The method of claim 1, wherein the first cooperative transceiving signal includes an asserted RF active signal over a plurality of transmit intervals and a single receive interval.

12. The method of claim 1, wherein the first cooperative transceiving signal includes an asserted RF active signal over a single transmit interval and a plurality of receive intervals.

13. A wireless device comprising:
host device components;
a Wireless Personal Area Network (WPAN) interface communicatively coupled to the host device components;
a Wireless Local Area Network (WLAN) interface communicatively coupled to the host device components;
shared TX/RX resources communicatively coupled to the WPAN interface and to the WLAN interface; and
wherein:
for WPAN connection setup operations of the WPAN interface, the WPAN interface is operable to provide a first cooperative transceiving signal to the WLAN interface via a cooperative transceiving interface; and
for non WPAN connection setup operations of the WPAN interface, the WPAN interface is operable to provide a second cooperative transceiving signal to the WLAN interface via the cooperative transceiving interface.

14. The wireless device of claim 13, wherein:
in WPAN interface providing the first cooperative transceiving signal to the WLAN interface via the cooperative transceiving interface, the WPAN interface is operable to:
assert an RF active signal for a first duration; and
assert a first priority signal;
in WPAN interface providing the second cooperative transceiving signal to the WLAN interface via the cooperative transceiving interface, the WPAN interface is operable to:
assert the RF active signal for a second duration that differs from the first duration; and
assert a second priority signal that differs from the first priority signal.

15. The wireless device of claim 14, wherein the WLAN interface is operable to provide a third cooperative transceiving signal to the WPAN interface via the cooperative transceiving interface.

16. The wireless device of claim 13, wherein:
in response to the first cooperative transceiving signal received from the WPAN interface via the cooperative transceiving interface, the WLAN interface is operable to provide priority access to the shared TX/RX resources to the WPAN interface; and
in response to the second cooperative transceiving signal received from the WPAN interface via the cooperative transceiving interface, the WLAN interface is operable to provide non priority access to the shared TX/RX resources to the WPAN interface.

17. The wireless device of claim 13, wherein:
the WPAN interface is operable to transceive data packets via the shared TX/RX resources in accordance with at least one version of the Bluetooth operating standard; and
the WLAN interface is operable to transceive data packets via the shared TX/RX resources in accordance with at least one version of the IEEE 802.11 operating standard.

18. The wireless device of claim 13, wherein:
the shared TX/RX resources comprise an antenna switch and at least one antenna;
the WLAN interface is operable to operate the antenna switch in a first manner in response to the first cooperative transceiving signal; and
the WLAN interface is operable to operate the antenna switch in a second manner in response to the second cooperative transceiving signal.

19. The wireless device of claim 13, wherein:
the connection setup operations comprise page mode operations during which the WPAN interface is operable to page another WPAN device; and
the first cooperative transceiving signal includes an asserted RF active signal over a plurality of transmit intervals and a plurality of receive intervals of the page mode operations.

20. The wireless device of claim 13, wherein:
the connection setup operations comprise page scan mode operations during which the WPAN interface is operable to receive a page from another WPAN device; and
the first cooperative transceiving signal includes an asserted RF active signal over a plurality of transmit intervals and a frame hope sequence receive interval of the page scan mode operations.

21. The wireless device of claim 13, wherein:
the connection setup operations comprise inquiry mode operations during which the WPAN interface is operable to inquire for at least one other WPAN device; and
the first cooperative transceiving signal includes an asserted RF active signal over a plurality of transmit intervals and a plurality of receive intervals of the inquiry mode operations.

22. The wireless device of claim 13, wherein the first cooperative transceiving signal includes an asserted RF active signal over a plurality of transmit intervals and a plurality of receive intervals.

23. The wireless device of claim 13, wherein the first cooperative transceiving signal includes an asserted RF active signal over a plurality of transmit intervals and a single receive interval.

24. The wireless device of claim 13, wherein the first cooperative transceiving signal includes an asserted RF active signal over a single transmit interval and a plurality of receive intervals.
